(19) United States
(12) Patent Application Publication
(10) Pub. No.: US 2023/0119123 A1
(43) Pub. Date: Apr. 20, 2023

(54) TORQUE TRANSMISSION DEVICE FOR A DRIVE DEVICE OF A PIECE OF FURNITURE, SHAFT BRAKE AND SHAFT COUPLING HAVING A TORQUE TRANSMISSION DEVICE OF THIS TYPE

(71) Applicant: Kesseböhmer Holding KG, Bad Essen (DE)

(72) Inventor: Holger STORCK, Damme (DE)

(73) Assignee: Kesseböhmer Holding KG, Bad Essen (DE)

(21) Appl. No.: 17/795,921

(22) PCT Filed: Jan. 25, 2021
(86) PCT No.: PCT/EP2021/051568

§ 371 Date: Jul. 28, 2022

(30) Foreign Application Priority Data
Jan. 29, 2020 (DE) 10 2020 201 052.8

(51) Int. Cl. F16D 43/21; F16D 13/16; F16D 51/12

(52) U.S. Cl. CPC F16D 43/211; F16D 13/16; F16D 51/12

(57) ABSTRACT

A rotation moment transmission device (1) for a driving device of a furniture comprises a housing (2) comprising a first friction surface (3) having a circular cross-section, a rotation moment transmission member (4) having a rotation axis (DA) and a second friction surface (5), wherein the second friction surface (5) is movable radially with respect to the rotation axis (DA) and the first friction surface (3) and the second friction surface (5) are configured to collaborate for a rotation moment transmission, and a rotation moment introduction member (6) which is rotatable about the rotation axis (DA). One of the rotation moment transmission member (4) and the rotation moment introduction member (6) comprises an engagement member, the other one thereof comprises a contact surface (8, 8′, 8″, 8‴, 8⁗) and the engagement member (7) is configured to the contact the contact surface (8, 8′, 8″, 8‴, 8‴′) such that a twisting of the rotation moment introduction member (6) relatively to the rotation moment transmission element (4) moves the second friction surface (5) with respect to the rotation axis (DA) radially towards the first friction surface (3) or away therefrom.

The invention relates to a rotation moment transmission device for a driving device of a furniture, and a shaft brake and a shaft clutch having such a rotation moment transmission device, in particular for a driving device of a furniture having driven adjustable components, the driving device having a drive and an actuator.

In the state of the art, driving devices for furniture having driven adjustable components are known. These driving devices comprise a drive and an actuator, for example, a lead screw or a threaded spindle. Via these driving devices, for example, height-adjustable tabletops of tables as being driven adjustable components of a furniture are moved upward or downward.

In order to prevent that these driven adjustable components autonomously displace, for example, that the tabletop lowers autonomously due to its weight, the threaded spindles and/or a transmission is designed such that self-retention is provided. Therefore, an elaborate brake having a separate control is not necessary. However, due to the design with self-retention, the driving device has a poor efficiency factor so that an increased energy consumption occurs during adjustment.

Further, there is also a request that the actuator is not always connected to the drive in order to be able to adjust the movable component of the furniture also without the drive, for example, by hand, without providing elaborate clutch mechanisms.

Therefore, the object underlying the invention is to provide a simple rotation moment transmission mechanism, the functional principle of which enables a shaft brake as well as a shaft clutch without additional controllers, as well as such a shaft brake and shaft clutch.

The object is achieved by a rotation moment transmission device according to claim 1, a shaft brake according to claim 9, and a shaft clutch according to claim 15. Advantageous further developments of the invention are included in the dependent claims.

According to an aspect of the invention, a rotation moment transmission device for a driving device of a furniture having driven adjustable components comprises a housing comprising a first friction surface having a circular cross section with a center axis, a rotation moment transmission member having a rotation axis and a second friction surface, wherein the second friction surface is movable radially with respect to the rotation axis, the rotation axis coincides with the center axis, and the first friction surface and the second friction surface are configured to collaborate for a rotation moment transmission, and a rotation moment introduction member which is rotatable about the rotation axis. One of the rotation moment transmission member and the rotation moment introduction member comprises an engagement member, the other one of the rotation moment transmission member and the rotation moment introduction member comprises a contact surface having a changing radial distance from the rotation axis in at least one angle range about the rotation axis. The engagement member is configured to contact the contact surface such that a twisting of the rotation moment introduction member relatively to the rotation moment transmission member moves the second friction surface radially with respect to the rotation axis towards the first friction surface or away therefrom.

By means of such a rotation moment transmission device, a rotation moment transmission in the driving device is possible by controlling the motor without the need of additional control elements or active actuators in the rotation moment transmission device.

According to an advantageous implementation of the rotation moment transmission device, the rotation moment transmission member comprises an elastic portion configured to attach the second friction surface to the rotation moment transmission member so as to be radially movably with respect to the rotation axis and fixed in a tangential direction.

By the elastic portion configured in such a manner, it is possible that a generation of a friction connection between the first friction face and the second friction face is easily possible, wherein the rotation moment can be safely transmitted.

In a further advantageous implementation of the rotation moment transmission device, the rotation moment transmission member comprises a spring element configured to the urge the second friction surface radially with respect to the rotation axis into a predetermined position.

By the provision of a predetermined position of the second friction surface, a characteristic related to a rotation moment transmission in the predetermined position of the second friction surface, namely, the rotation moment transmission or a prevention of the rotation moment transmission, can be provided in a defined manner.

In a further advantageous implementation of the rotation moment transmission device, the engagement member is formed as a protrusion, preferably as a pin having a cylindrical cross-section, further preferably, at least in sections.

Such an engagement member can easily be manufactured and enables a safe and lowwear operation.

In a further advantageous implementation of the rotation moment transmission device, the first friction surface is formed by an inner surface of the housing facing the rotation axis and the second friction face is formed by a surface of the rotation moment transmission member averted from the rotation axis.

The inner surface of the housing as the first friction surface and the second friction surface of the rotation moment transmission member averted from the rotation axis can be easily manufactured with the characteristics necessary for friction surfaces.

In another advantageous implementation of the rotation moment transmission device, the first friction surface is formed by a surface of the housing averted from the rotation axis and the second friction surface is formed by a surface of the rotation moment transmission member facing the rotation axis.

Due to the arrangement of the friction surfaces, such a rotation moment transmission device can be provided with a small outer diameter.

According to a further advantageous implementation of the rotation moment transmission device, the rotation moment transmission member comprises a radially-movable portion on which the second friction surface is arranged and the contact surface or the engagement member is provided on the at least one radially-movable portion.

By the provision of the contact surface or engagement member on the radially-movable portion of the rotation moment transmission member, there is the option to safely determine a position of the second friction surface with respect to the first friction surface, wherein a shape of the second friction surface can be formed advantageously in order to enable an optimum friction pairing.

In a further advantageous implementation of the rotation moment transmission device, the rotation moment transmission member comprises a rotation shaft about the rotation axis, and the spring element, the rotation shaft, and the radially-movable portion are formed integrally.

By the integral configuration, the rotation moment transmission device can be economically provided since a mounting work, for example, for a subassembly, is omitted.

According to a further aspect of the invention, a shaft brake for a driving device of a furniture having driven adjustable components is provided. The driving device comprises a drive and an actuator and the shaft brake comprises a rotation moment transmission device, wherein the rotation moment introduction member can be connected to the drive to introduce a rotation moment into the rotation moment transmission device, and the rotation moment transmission member can be connected to the actuator to discharge a rotation moment out of the rotation moment transmission device. The rotation moment transmission member further comprises a spring element configured to urge the second friction surface radially into a predetermined position in which the second friction surface contacts the first friction surface of the housing to generate a friction contact therebetween. The driving device has a first direction of rotation and the contact surface comprises a first contact surface configured to radially move away the second friction surface from the first friction surface when twisting the rotation moment introduction member relatively to the rotation moment transmission member in the first direction of rotation in order to eliminate the friction contact between the first friction surface and the second friction surface.

By such a shaft brake, the shaft can be braked in a controlled manner without an additional controller or active actuators. In a state in which it is not particularly controlled or supplied with energy, the shaft brake has a braking effect so that a braking function is also guaranteed when the energy supply fails or is separated.

In a further advantageous implementation of the shaft brake, a distance from the first contact surface to the rotation axis gets larger in the at least one angle range in the first direction of rotation in order to radially move the second friction surface towards the first friction surface and away from it when the rotation moment introduction member is twisted relatively to the rotation moment transmission element in the first direction of rotation.

When the distance gets larger in the angle range, it is possible to determine the behavior of the shaft brake so that a release of the shaft brake can happen in a defined manner.

According to a further advantageous implementation of the shaft brake, the driving device has the first driving direction of rotation and a second direction of rotation opposite to the first driving direction of rotation, and the contact surface comprises a second contact surface configured to move the second friction surface towards the first friction surface when the rotation moment introduction member is twisted in the second direction of rotation relatively to the rotation moment transmission member.

By the second contact surface, it is possible to enhance the braking effect of the shaft brake.

In a further advantageous implementation of the shaft brake, a distance from the second contact surface to the rotation axis gets smaller in the at least one angle range in the second direction of rotation in order to radially move the second friction surface away from the rotation axis and towards the first friction surface when the rotation moment introduction member is twisted relatively to the rotation moment transmission member in the second direction of rotation.

By the reduction of the distance in the angle range, it is possible to determine the behavior of the shaft brake so that the enhanced braking of the shaft brake can be provided in a defined manner.

According to a further advantageous implementation of the shaft brake, the driving device has the first direction of rotation and the second direction of rotation opposite to the first direction of rotation, and the contact surface comprises a third contact surface configured to radially move the second friction surface away from the first friction surface when the rotation moment introduction member is twisted relatively to the rotation moment transmission member in the second direction of rotation.

By such an implementation, it is possible to release the shaft brake in both directions of rotation in a defined manner since the shaft brake is released when the engagement member contacts the first contact surface as well as the third contact surface.

In a further advantageous implementation of the shaft brake, the first contact surface configured to radially move the second friction surface away from the first friction surface when the rotation moment introduction member is twisted relatively to the rotation moment transmission member in the first direction of rotation and the third contact surface configured to radially move the second friction surface away from the first friction surface when the rotation moment introduction member is twisted relatively to the rotation moment transmission member in the second direction of rotation are respectively provided on circumferentially opposite sides of the radially-movable portions.

In this implementation, the shaft brake can be released in both directions of rotation in order to enable an adjustment without high effort upon specific requirements.

According to a further aspect of the invention, a shaft clutch for a driving device of a furniture with driven adjustable components comprises a drive and an actuator, and the shaft clutch comprises the rotation moment transmission device. The rotation moment introduction member can be connected to the drive in order to transmit a rotation moment to the shaft clutch, and the housing can be connected to the actuator in order to transmit a rotation motion from the shaft clutch. The rotation moment transmission member comprises a spring element configured to urge the second friction surface radially into a predetermined position in which the second friction surface is not in contact with the first friction surface, the driving device has a driving direction of rotation, and the contact surface comprises a fourth contact surface configured to move the second friction surface radially towards the first friction surface in order to generate a friction contact between the first friction surface and the second friction surface when the rotation moment introduction member is twisted relatively to the rotation moment transmission member in the driving direction of rotation.

By this shaft clutch, it is easily possible to admit a free run of the actuator, wherein the drive is automatically coupled to the actuator when the rotation moment is introduced into the shaft clutch.

In an advantageous implementation of the shaft clutch, the distance from the fourth contact surface to the rotation axis gets smaller in the driving direction of rotation in the at least one angle range.

Thereby, it is possible to determine the behavior of the shaft clutch such that coupling by the shaft clutch can be provided in a defined manner.

Subsequently, the invention is elucidated by means of embodiments referring to the attached drawings.

In particular,

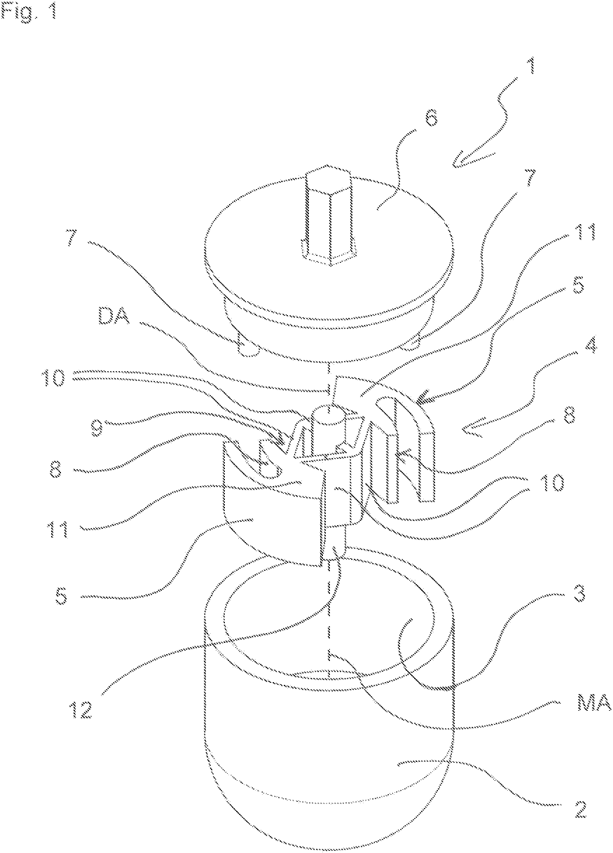

FIG. 1 shows an exploded illustration of a first embodiment of a rotation moment transmission device as a shaft brake;

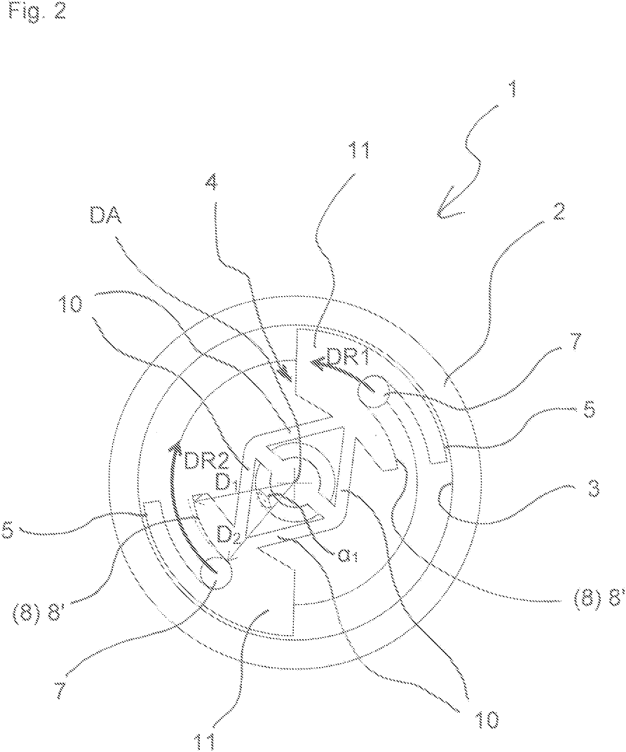

FIG. 2 shows a plan view on a housing and a rotation moment transmission member of the rotation moment transmission device of FIG. 1 as the shaft brake in a released state;

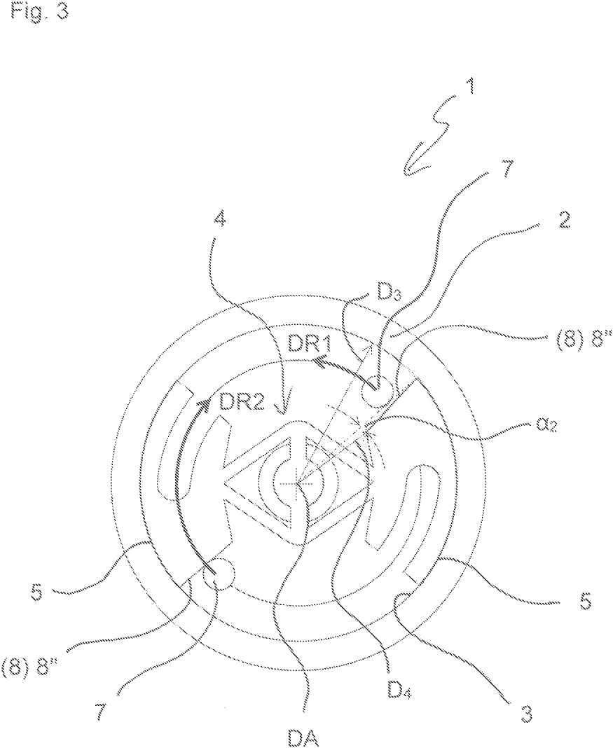

FIG. 3 shows a plan view on the housing and the rotation moment transmission member of the rotation moment transmission device of FIG. 1 as the shaft brake in a state in which the braking effect is enhanced;

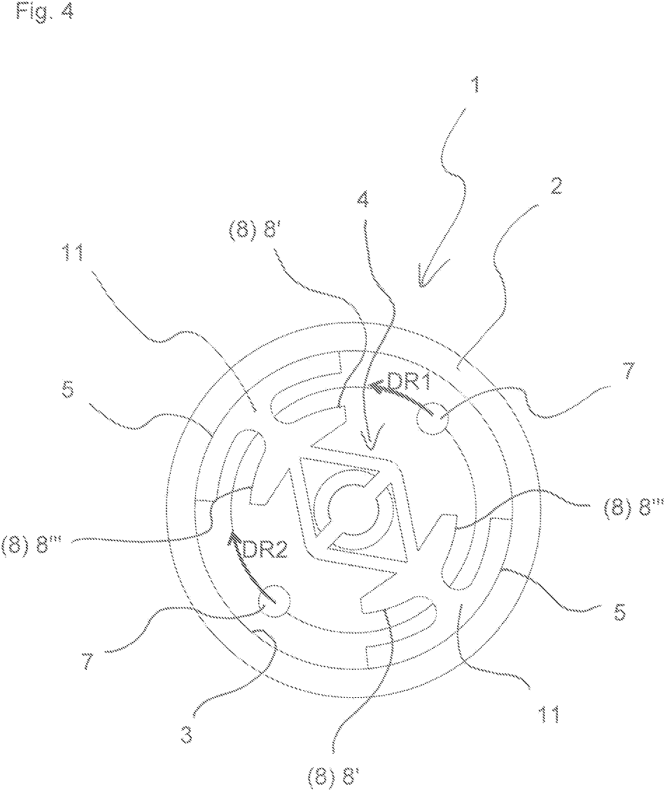

FIG. 4 shows a plan view on a housing and a rotation moment transmission member of the rotation moment transmission device according to a second embodiment as a shaft brake in a braked state;

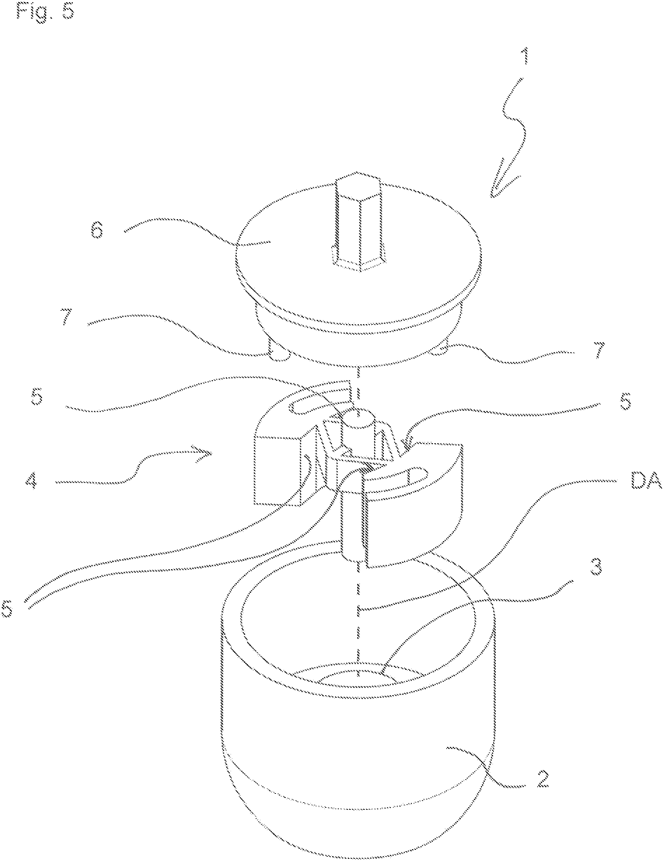

FIG. 5 shows an exploded illustration of a third embodiment of the rotation moment transmission device as a shaft brake;

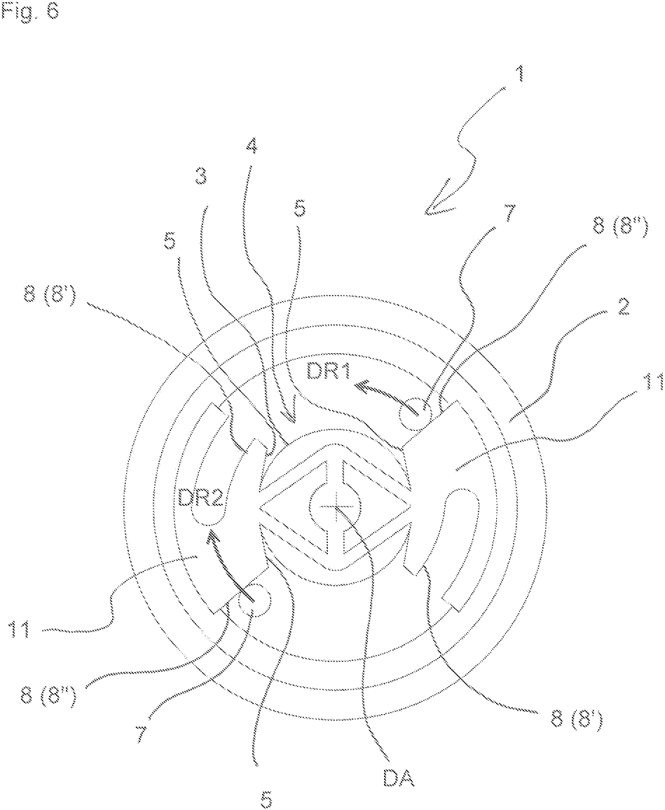

FIG. 6 shows a plan view on a housing and a rotation moment transmission member of the rotation moment transmission device of FIG. 5 as the shaft brake in a released state;

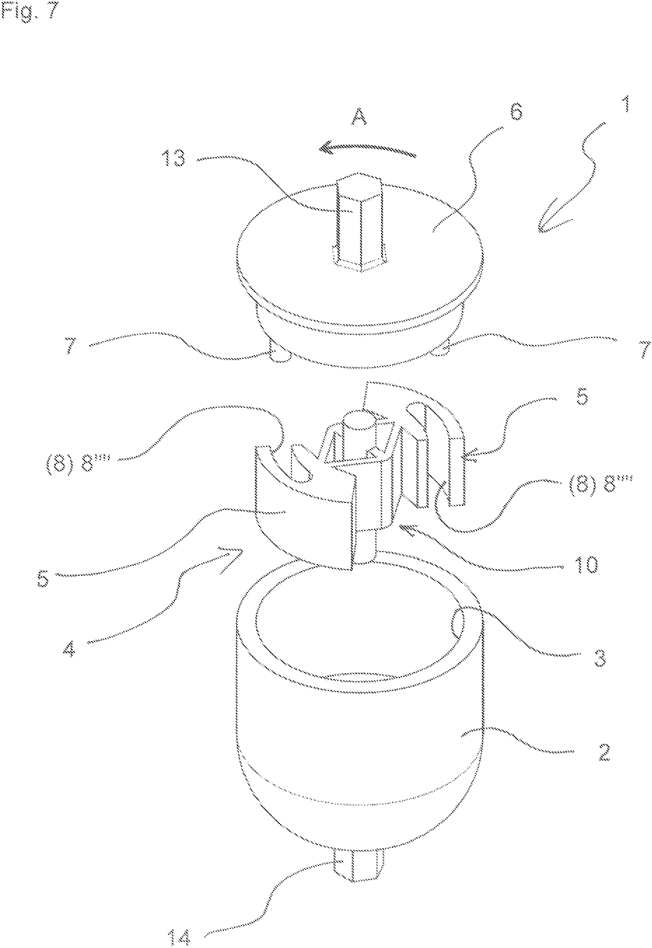

FIG. 7 shows an exploded view of a fourth embodiment of the rotation moment transmission device according to the invention as a shaft clutch.

FIG. 1 shows an exploded illustration of a first embodiment of a rotation moment transmission device 1 according to the invention as a shaft brake for a driving device of a furniture having driven adjustable components.

The rotation moment transmission device 1 comprises a housing 2 comprising a first friction surface 3 having a circular cross-section with a center axis MA.

Further, the rotation moment transmission device 1 comprises a rotation moment transmission member 4. The rotation moment transmission member 4 has a rotation axis DA and comprises two second friction surfaces 5. The second friction surfaces 5 are radially movable with respect to the rotation axis DA coinciding with the center axis MA so that the first friction surface 3 and the second friction surfaces 5 collaborate for a rotation moment transmission when they contact one another.

The first friction surface 3 is an inner surface of the housing 2 facing the rotation axis DA and the second friction surfaces 5 are surfaces of the rotation moment transmission member 4 averted from the rotation axis DA. Alternatively, as described below, the first friction surface 3 is a surface of the housing 2 averted from the rotation axis DA and the second friction surface 5 is a surface of the rotation moment transmission member 4 facing the rotation axis DA.

The rotation moment transmission member 4 comprises an elastic portion 9 so that the second friction surfaces 5 are attached to the rotation moment transmission member 4 so as to be radially movably with respect to the rotation axis DA and fixed in a tangential direction.

As the elastic portion 9, the rotation moment transmission member 4 comprises spring elements 10 which urge the second friction surfaces 5 into a predetermined position. The predetermined position determines a defined distance of the second friction surfaces 5 from the rotation axis DA. In the predetermined position, the first friction surface 3 and the second friction surfaces 5 can either contact one another in order to transmit a rotation moment or they can be spaced from one another in order to prevent a rotation moment transmission. Alternatively, no spring element 10 or no elastic portion 9 is provided but, for example, a guiding device which supports the second friction surfaces 5 so as to be radially movably with respect to the rotation axis (DA) and fixed in a tangential direction is provided.

Moreover, the rotation moment transmission device 1 comprises a rotation moment introduction member 6 which is rotatable about the rotation axis DA.

The rotation moment introduction member 6 comprises two protrusions 7 as two engagement members and the rotation moment transmission member 4 comprises two contact surfaces 8. The contact surfaces 8 have a changing radial distance from the rotation axis DA in an angle range about the rotation axis DA and the protrusions 7 contact the contact surfaces 8 such that a twisting of the rotation moment introduction member 6 relatively to the rotation moment transmission member 4 moves the second friction surfaces 5 radially towards the rotation axis DA or away therefrom, therefore towards the first friction surface 3 or away from the first friction surface 3.

The rotation moment transmission member 4 further comprises two radially-movable portions 11 on which one of the two second friction surfaces 5 is arranged respectively. On the radially-movable portions 11, the contact surfaces 8 are provided.

Moreover, the rotation moment transmission member comprises a rotation shaft 12 about the rotation axis DA and the rotation shaft 12, the spring elements 10 and the radially-movable portions 11 are formed integrally.

In alternative embodiments, not the two second friction surfaces 5, the two protrusions 7 as the engagement elements, the two contact surfaces 8 and the two radially-movable portions 11 are provided but merely one second friction surface 5, one engagement element, one contact surface 8, and one radially-movable portion 11 or more than two second friction surfaces 5, engagement elements, contact surfaces 8 and radially-movable portions 11 are provided. Also, it is alternatively possible that the engagement members are not provided on the rotation moment introduction member 6 but on the rotation moment transmission member 4 or the radially-movable portions 11 and the contact surfaces 8 are not provided on the rotation moment transmission member 4 or the radially-movable portions 11 but on the rotation moment introduction member 6. Moreover, it is alternatively also possible that the rotation shaft 12, the spring elements 10, and the radially-movable portions 11 are not formed integrally but as individual components.

The protrusions 7 respectively comprise a pin having a cylindrical cross-sectional at least in sections. Alternatively, protrusions formed in another manner, for example, tapered or pimple-shaped are provided.

FIG. 2 shows a plan view on the housing 2 and the rotation moment transmission member 4 of the rotation moment transmission device 1 of FIG. 1 of a shaft brake in a released state. The shaft brake is provided for a driving device of a furniture having driven adjustable components, wherein the driving device comprises a drive (not shown) and an actuator (not shown).

Here, the protrusions 7 of the rotation moment introduction member 6 (FIG. 1) are merely shown. The rotation moment introduction member 6 is connected to the drive in order to introduce a rotation moment into the rotation moment transmission device 1. The rotation moment transmission member 4 is connected to the actuator via the rotation shaft 12 (FIG. 1) to discharge a rotation moment out of the rotation moment transmission device 1.

The rotation moment transmission member 4 comprises the spring element 10 which, in the shaft brake, urges the second friction surfaces 5 radially into a predetermined position in which the second friction surfaces 5 contact the first friction surface 3 of the housing 2 in order to generate a friction contact.

The driving device has a first direction of rotation DR1 which is transmitted to the rotation moment introduction member 6 and, therefore, to the protrusions 7.

The contact surfaces 8 respectively comprise a first contact surface 8′ configured to radially move the second friction surfaces 5 towards the rotation axis DA when the rotation moment introduction member 6, or the protrusions 7, are twisted relatively to the rotation moment transmission member 4 in the first direction of rotation DR1. Thereby, the second friction surfaces 5 move away from the first friction surface 3 in order to eliminate a friction contact between the first friction surface 3 and the second friction surfaces 5.

As can be seen in FIG. 2, thereto, the contact surfaces 8′ have, on outer edges of the radially movable portions 11, a distance D1 from the rotation axis DA and a distance D2 from the rotation axis DA in an angular distance α₁, namely, at positions where the protrusions 7 are illustrated. The distance D2 is larger than the distance D1 so that the distance of the first contact surface 8′ to the rotation axis DA gets larger in the at least one angle range α₁ in the first direction of rotation DR1. Alternatively, angle ranges in which the distance, for example, remains identically can also be provided.

FIG. 3 shows a plan view on the housing 2 and the rotation moment transmission member 4 of the rotation moment transmission device 1 of FIG. 1 of the shaft brake in a state, in which the brake effect is enhanced.

The contact surfaces 8 comprise second contact surfaces 8″ configured to move the second friction surfaces 5 radially away from the rotation axis DA when the rotation moment introduction member 6, or the protrusions 7, are twisted relatively to the rotation moment transmission member 4 in a second direction of rotation DR2 opposite to the first direction of rotation DR1. Thereby, a force of the second friction surfaces 5 in direction of the first friction surface 3 is enlarged in order to enhance the friction contact between the first friction surface 3 and the second friction surfaces 5.

As can be seen in FIG. 3, thereto, the contact surfaces 8″ have a distance D3 from the rotation axis DA at the outer circumferences of the radially-movable portions 11 and, in an angular distance α₂, namely at inner edges of the contact surfaces 8″, a distance D4 from the rotation axis DA. The distance D3 is larger than the distance D4 so that the distance from the second contact surface 8″ to the rotation axis DA decreases in the at least one angular range α₂ in the second direction of rotation DR2 in order to move the second friction surface 5 radially away from the rotation axis DA and towards the first friction surface 3 when the rotation moment introduction member 6 is twisted relatively to the rotation moment transmission member 4 in the second rotation direction DR2.

The effect of the increase of the friction contact is enhanced by a low elasticity of the spring elements 10 in tangential direction so that the second friction surfaces 5 are pressed on the first friction surface 3 in the tangential direction by the protrusions 7 and, except from that, the effect of a primary brake shoe is used.

FIG. 4 shows a plan view on the housing 2 and the rotation moment transmission member 4 of the rotation moment transmission device 1 according to the second embodiment as a shaft brake in a braked state. The rotation moment transmission device 1 according to the second embodiment distinguishes from the rotation moment transmission device 1 according to the first embodiment only by that a first contact surface 8′ configured to radially move the second friction surfaces 5 towards the rotation axis DA when the rotation moment introduction member 6, or the protrusions 7, are twisted relatively to the rotation moment transmission member 4 in the first direction of rotation DR1 and a third contact surface 8‴ configured to also radially move the second friction surfaces 5 towards the rotation axis DA when the rotation moment introduction member 6, or the protrusions 7, are twisted relatively to the rotation moment transmission member 4 in the second direction of rotation DR2 are provided. Thereby, the second friction surfaces 5 respectively move away from the first friction surface 3 in order to eliminate the friction contact between the first friction surface 3 and the second friction surfaces 5.

FIG. 5 shows an exploded illustration of a third embodiment of the rotation moment transmission device 1 as the shaft brake and FIG. 6 shows a plan view on the housing 2 and the rotation moment transmission member 4 of the rotation moment transmission device 1 of FIG. 5 as shaft brake in a released state.

In this third embodiment, as described above as alternative, the first friction surface 3 is a surface of the housing 2 averted from the rotation axis DA and the second friction surfaces 5 are surfaces of the rotation moment transmission member 4 facing the rotation axis DA.

Since the rotation moment introduction member 6, or the protrusions 7, contact the second contact surfaces 8″ in the second direction of rotation DR2 in the shown position, the radially-movable portions 11 with the second friction surfaces 5 are moved outwardly, therefore, away from the rotation axis DA, by means of the second contact surfaces 8″ analogously to the first embodiment. Thereby, in this third embodiment, the second friction surfaces 5 are moved away from the first friction surface 3 and the friction contact, therefore, the braking effect, is eliminated.

When the rotation moment introduction member 6, or the protrusions 7, are moved relatively to the housing 2 in the first direction of rotation DR1, the protrusions 7 engage with the first contact surfaces 8′ and move, like in the first embodiment, the second friction surfaces 5 towards the rotation axis DA. Thereby, in this third embodiment, the braking effect is generated or enhanced via the second friction surfaces 5 and the first friction surface 3.

FIG. 7 shows an exploded illustration of a fourth embodiment of the rotation moment transmission devices 1 of a shaft clutch. The shaft clutch is used in a driving device of a furniture having driven adjustable components, wherein the driving device comprises a drive (not shown) and an actuator (not shown).

The rotation moment introduction member 6 can be connected to the drive to transmit a rotation moment to the shaft clutch. Thereto, the rotation moment introduction member is provided with a first hex-protrusion 13. The housing 2 can be connected to the actuator to transmit a rotation moment from the shaft clutch thereto. For that, the housing is provided with a second hex-protrusion 14.

The rotation moment transmission member 4 comprises the spring element 10 which urges the second friction surface 5 radially into a predetermined position in which the second friction surface 5 does not contact the first friction surface 3 of the housing 2.

The driving device has a driving direction of rotation A and the contact surface 8 comprises a fourth contact surface 8⁗ configured to move the second friction surface 5 radially away from the rotation axis DA, therefore towards the first friction surface 3 when the rotation moment introduction member 6, or the protrusions 7, are twisted relatively to the rotation moment transmission member 4 in the driving direction of rotation A in order to generate or enhance a friction contact between the first friction surface 3 and the second friction surfaces 5. Thereto, the distance from the fourth contact surface 8‴′ to the rotation axis DA gets smaller in at least one angle range in the driving direction of rotation A.

In operation as shaft brake with the rotation moment transmission device 1 according to one of the first to third embodiment, if the protrusions 7 do not contact one of the contact surfaces 8 as shown in FIG. 4, the second friction surface 5 is in contact with the first friction surface 3 so that a friction contact exists between the rotation moment transmission member 4 and the housing 2. The housing 2 is fixed to a component of the furniture in a non-twistable manner and, thus, twisting of the rotation moment transmission member 4, and, therefore, of the actuator connected thereto, is prevented and the actuator is thereby braked.

When the rotation moment introduction member 6 is twisted relatively to the rotation moment transmission member 4 in the first direction of rotation DR1, the protrusions 7 contact the first contact surfaces 8′ and, by the distance between the rotation axis DA and the first contact surface 8′ getting larger in the direction of rotation DR1, the radially-movable portions 11 are moved radially towards the rotation axis DA. Thereby, the friction contact between the first friction surface 3 and the second friction surfaces 5 is eliminated and the rotation moment can be transmitted in an unbraked manner. This happens, for example, for an upward motion of a tabletop.

When twisting the rotation moment introduction member 6 relatively to the rotation moment transmission member 4 in the second direction of rotation DR2, the protrusions 7 are no longer in contact with the first contact surfaces 8′ so that the second friction surfaces 5 move again towards the first friction surface 3 so that the rotation moment transmission device 1 brakes the actuator again. This breaks the actuator, for example, when an adjustment of the tabletop is not intended.

When the rotation moment transmission member 6 is further twisted relatively to the rotation moment transmission member 4 according to the first or third embodiment of the rotation moment transmission device 1 in the second direction of rotation DR2, the protrusions 7 contact the second contact surfaces 8″ and, thus, urge the radially-movable portions 11 with the second friction surfaces 5 away from the rotation axis DA towards the first friction surface 3. Thereby, a braking effect is generated or enhanced. For example, this happens for a downward motion of the tabletop in order to prevent a load onto the drive upon higher weights on the tabletop.

On the other hand, according to the second embodiment of the rotation moment transmission device 1, when the rotation moment introduction member 6 is further twisted relatively to the rotation moment transmission member 4 in the second direction of rotation DR2, the protrusions 7 contact the third contact surfaces 8‴ and, thus, urge the radially-movable portions 11 with the second friction surfaces 5 towards the rotation axis DA, therefore, away from the first friction surface 3. For example, this happens when no braking effect is necessary or intended during a downward movement of the tabletop.

In operation as shaft clutch with the rotation moment transmission device 1 according to the fourth embodiment, insofar as the protrusions 7 do not contact one of the contact surfaces 8, the second friction surface 5 is not in contact with the first friction surface 3 so that no friction contact exists between the rotation moment transmission member 4 and the housing 2. Therefore, the actuator connected to the rotation moment transmission member 4 is freely movable.

When moving the rotation moment introduction member 5 relatively to the rotation moment transmission member 4 in the first direction of rotation DR1, the protrusions 7 come in contact with the fourth contact surfaces 8‴′ and, by the distance between the rotation axis DA and the fourth contact surface 8‴′ getting smaller in the direction of rotation DR1, the radially-movable portions 11 are moved away from the rotation axis DA and the second friction surfaces 5 are moved towards the first friction surface 3. Thereby, the friction contact between the first friction surface 3 and the second friction surfaces 5 is generated or enhanced and the rotation moment can be transmitted.

When a further one of the contact surfaces 8 for a further driving direction opposite to the driving direction A is analogously provided, a coupling of the drive and the actuator can also be performed in the further driving direction.

All features illustrated in the description, the subsequent claims, and the drawing can be essential for the invention individually as well as in an arbitrary combination.

1. A rotation moment transmission device for a driving device of a furniture having driven adjustable components, wherein the rotation moment transmission device comprises:
a housing comprising a first friction surface having a circular cross-section with a center axis,
a rotation moment transmission member having a rotation axis and a second friction surface, wherein the second friction surface is movable radially with respect to the rotation axis, the rotation axis coincides with the center axis, and the first friction surface and the second friction surface are configured to collaborate for a rotation moment transmission, and
a rotation moment introduction member which is rotatable about the rotation axis, wherein
one of the rotation moment transmission member and the rotation moment introduction member comprises an engagement member,
the other one of the rotation moment transmission member and the rotation moment introduction member comprises a contact face having a changing radial distance from the rotation axis in at least one angle rang about the rotation axis, and
the engagement member is configured to contact the contact face, such that a twisting of the rotation moment introduction member relatively to the rotation moment transmission member moves the second friction surface radially with respect to the rotation axis towards the first friction surface or away therefrom.

2. The rotation moment transmission device according to claim 1, wherein
the rotation moment transmission member comprises an elastic portion configured to attach the second friction surface to the rotation moment transmission member so as to be radially movably with respect to the rotation axis and fixed in a tangential direction.

3. The rotation moment transmission device according to claim 2, wherein
the rotation moment transmission member comprises a spring element configured to urge the second friction surface radially with respect to the rotation axis (DA) into a predetermined position.

4. The rotation moment transmission device according to claim 1, wherein
the engagement member is formed as a protrusion preferably as a pin having a cylindrical cross-section, further preferably, at least in sections.

5. The rotation moment transmission device according to claim 1 wherein
the first friction surface is formed by an inner surface of the housing facing the rotation axis (DA) and the second friction surface is formed by a surface of the rotation moment transmission member averted from the rotation axis.

6. The rotation moment transmission device according to claim 1, wherein
the first friction surface is formed by a surface of the housing averted from the rotation axis (DA) and the second friction surface is formed by a surface of the rotation moment transmission member facing the rotation axis.

7. The rotation moment transmission device according to claim 1, wherein
the rotation moment transmission member comprises a radially-movable portion on which the second friction surface is arranged, and
the contact surface or the engagement member is provided on the radially-movable portion.

8. The rotation moment transmission device according to claim 7, wherein
the rotation moment transmission member comprises a rotation shaft about the rotation axis, and
the spring element, the rotation shaft, and the radially-movable portion are formed integrally.

9. A shaft brake for a driving device of a furniture having driven adjustable components, wherein the driving device comprises a drive and an actuator, and wherein
the shaft brake comprises a rotation moment transmission device according to claim 1,
wherein the rotation moment transmission member comprises an elastic portion configured to attach the second friction surface to the rotation moment transmission member so as to be radially movably with respect to the rotation axis and fixed in a tangential direction,
wherein the rotation moment transmission member comprises a spring element configured to urge the second friction surface radially with respect to the rotation axis into a predetermined position; and
wherein the rotation moment introduction member is connected to the drive to introduce a rotation moment into the rotation moment transmission device, the rotation moment transmission member is connected to the actuator to discharge a rotation moment out of the rotation moment transmission device,
the rotation moment transmission member comprises the spring element configured to urge the second friction surface radially into a predetermined position in which the second friction surface contacts the first friction surface of the housing to generate a friction contact therebetween,
the driving device has a first direction of rotation, and
the contact surface comprises a first contact surface configured to move the second friction surface radially away from the first friction surface when twisting the rotation moment introduction member
relatively to the rotation moment transmission member in the first direction of rotation in order to eliminate the friction contact between the first friction surface and the second friction surface.

10. The shaft brake according to claim 9, wherein a distance from the first contact surface to the rotation axis gets larger in at least one angle range in the first direction of rotation in order to move the second friction surface radially towards the rotation axis (DA) and away from first frictional surface when the rotation moment introduction member is twisted relatively to the rotation moment transmission element in the first direction of rotation.

11. The shaft brake according to claim 9, wherein
the driving device has the first direction of rotation and a second direction of rotation opposite to the first direction of rotation, and
the contact surface comprises a second contact surface configured to move the second friction surface radially towards the first friction surface when the rotation moment introduction member is twisted relatively to the rotation moment transmission member.

12. The shaft brake according to claim 11, wherein a distance from the second contact surface to the rotation axis (DA) gets smaller in the at least one angle range in the second direction of rotation in order to move the second friction surface radially away from the rotation axis and towards the first friction surface when the rotation moment introduction member is twisted relatively to the rotation moment transmission member.

13. The shaft brake according to claim 9, wherein
the driving device has the first direction of rotation and a second direction of rotation opposite to the first direction of rotation,
the contact surface comprises a third contact surface configured to move the second friction surface radially away from the first friction surface when the rotation moment introduction member is twisted relatively to the rotation moment transmission member in the second direction of rotation.

14. The shaft brake according to claim 13, wherein the rotation moment transmission member comprises a radially-movable portion on which the second friction surface is arranged, and
the contact surface or the engagement member is provided on the radially-movable portion, wherein
the first contact surface configured to move the second friction surface radially away from the first friction surface when the rotation moment introduction member is twisted relatively to the rotation moment transmission member in the first direction of rotation and a third contact surface configured to move the second friction surface radially away from the first friction surface when the rotation moment introduction member is twisted relatively to the rotation moment transmission member in the second direction of rotation are respectively provided on circumferentially opposite sides of the radially-movable portions.

15. A shaft clutch for a driving device of a furniture having driven adjustable components, wherein
the driving device comprises a drive and an actuator,
the shaft clutch comprises a rotation moment transmission device according to claim 1,
the rotation moment introduction member is connected with the drive to transmit a rotation moment into the shaft clutch, the housing is connected with the actuator in order to transmit a rotation moment from the shaft clutch,
the rotation moment transmission member comprises a spring element configured to urge the second friction surface radially into a predetermined position in which the second friction surface does not contact the first friction surface of the housing,
the driving device has a driving direction of rotation, and
the contact surface comprises a fourth contact surface configured to move the second friction surface radially towards the first friction surface in order to generate a friction contact between the first friction surface and the second friction surface when the rotation moment introduction member is twisted relatively to the rotation moment transmission member in the driving direction of rotation.

16. The shaft clutch according to claim 15, wherein a distance from the fourth contact surface to the rotation axis (DA) gets smaller in the at least one angle range in the driving direction of rotation.

17. The shaft brake according to claim 14, wherein the rotation moment transmission member comprises a rotation shaft about the rotation axis, and the spring element, the rotation shaft, and the radially-movable portion are formed integrally.
